(19) United States
(12) Patent Application Publication
(10) Pub. No.: US 2021/0287674 A1
(43) Pub. Date: Sep. 16, 2021

(54) VOICE RECOGNITION FOR IMPOSTER REJECTION IN WEARABLE DEVICES

(71) Applicant: Knowles Electronics, LLC, Itasca, IL (US)

(72) Inventors: Andy Unruh, Itasca, IL (US); Wenjing Yang, Itasca, IL (US); Bin Jiang, Itasca, IL (US); Stephen Cradock, Itasca, IL (US); Alexei Ivanov, Itasca, IL (US); Fuliang Weng, Itasca, IL (US); Scott Choi, Itasca, IL (US)

(73) Assignee: Knowles Electronics, LLC, Itasca, IL (US)

(21) Appl. No.: 17/202,093

(22) Filed: Mar. 15, 2021

Related U.S. Application Data
(60) Provisional application No. 62/990,410, filed on Mar. 16, 2020.

(51) Int. Cl. G10L 15/22; H04R 1/08; H04R 3/04; G10L 15/06; G10L 15/08

(52) U.S. Cl. CPC G10L 15/22; H04R 1/08; G10L 2015/088; G10L 15/063; G10L 15/08; H04R 3/04

(57) ABSTRACT

Various methods, systems, and apparatus are disclosed with improved imposter rejection for keyword recognition systems in a wearable device. Speech signals are measured by a microphone and a vibration sensor, the vibration sensor configured to measure vibrations in the body of a wearer of the device. An audio signal from the microphone and a vibration signal from the vibration sensor are input into a classifier to determine whether the wearer of the device spoke the keyword. In some embodiments, high-frequency components of a signal from the microphone may be combined with low-frequency components of a signal from the vibration sensor to generate a combined speech signal. The classifier may use a classification model trained with positive training data of the wearer speaking the keyword and negative training data of a non-wearer speaking the keyword.

### CROSS-REFERENCE TO RELATED APPLICATIONS

The present application claims the benefit of and priority to U.S. Provisional Application No. 62/990,410, filed Mar. 16, 2020, the disclosure of which is incorporated herein by reference in its entirety.

### TECHNICAL FIELD

The present disclosure relates generally to the field of voice recognition technology, and more specifically, improved imposter rejection in keyword recognition systems.

### BACKGROUND

Speech recognition systems are generally known to convert spoken language into written text or other computer-usable forms. Speech recognition systems may be implemented partially or entirely in wearable electronic devices, such as, for example, headphones, earbuds, or other wearable devices. Speech recognition may employ a keyword trigger wherein a user of the device is required to say a keyword prior to giving a command. Systems may operate in an always-on configuration such that the system is constantly analyzing an audio stream for a spoken keyword and/or command.

It is generally desirable for the speech recognition system to distinguish the keyword from unrelated speech and noise. Unrelated speech may include speech from a person or speaker in the vicinity of the wearable device but not wearing the wearable device. A non-wearer may induce a false positive trigger event when the non-wearer speaks the keyword. There exists a need for a speech recognition system with reduced false positive events from non-wearers without requiring user-specific implementations.

Previously, some systems have implemented a secondary trigger mechanism, wherein measured bone vibration is used to attribute speech received by a microphone is from a wearer of the device. However, such systems may still create false positive trigger events when a wearer is speaking at the same time a non-wearer speaks the keyword. Some other systems implement speaker-specific triggering events; however, speaker-specific implementations can be burdensome to accurately configure for each user.

### SUMMARY

Various embodiments of the present disclosure relate to a method for keyword recognition in a wearable device, the method comprising the steps of generating an audio signal from a spoken word detected by a microphone; generating a vibration signal from the spoken word detected by a vibration sensor, the vibration signal having a frequency component below frequencies of the audio signal; and determining whether a keyword was spoken by a wearer of the wearable device based on the audio signal and the vibration signal, wherein the keyword is rejected responsive to a determination the keyword was not spoken by the wearer of the wearable device.

In some embodiments, generating the audio signal includes filtering an output of the microphone using a high-pass filter and generating the vibration signal includes filtering the output of the vibration sensor using a low-pass filter, the method further comprising combining the audio signal and the vibration signal prior to determining whether the keyword was spoken by the wearer.

In some embodiments, generating the vibration signal further includes processing the low-frequency component of the vibration signal with an equalizer.

In some embodiments, the high-pass filter and the low-pass filter have a common cutoff frequency.

In some embodiments, the cutoff frequency is approximately 600 Hz.

In some embodiments, determining whether a keyword was spoken by the wearer of the wearable device further is performed using a classification model.

In some embodiments, the classification model is trained using a negative training set comprising speech samples simulating non-wearers of the device.

In some embodiments, the keyword is a trigger keyword, and the method further includes sending a control signal to a processing circuit responsive to the determination the keyword was spoken by the wearer.

Various embodiments of the present disclosure relate to a wearable apparatus comprising a microphone configured to measure acoustic signals from the air; a vibration sensor configured to measure vibration signals from the body of a user of the apparatus; and a classifier configured to receive a first signal from the microphone and a second signal from the vibration sensor, the second signal comprising frequencies below frequencies of the first signal; combine the first signal and the second signal to generate a processed speech signal; and determine whether a keyword was spoken by the user of the apparatus based on the processed speech signal.

In some embodiments, the apparatus is a device configured to be worn in or near the ear of the user.

In some embodiments, the vibration sensor is configured to measure vibrations from the inside of the ear of the user.

In some embodiments, the apparatus further includes a high-pass filter coupled to an output of, and configured to process signals from, the microphone; a low-pass filter coupled to an output of, and configured to process signals from, the vibration signal; and a digital signal processor implementing classification of the processed speech signal.

In some embodiments, the apparatus includes an equalizer, the equalizer coupled to the output of, and configured to process signals from, the low-pass filter, wherein the equalizer changes the amplitude of one or more frequency bands in the second filtered signal.

In some embodiments, the digital signal processor is configured to send a control signal to an application processor responsive to a determination the keyword was spoken by the user of the apparatus.

In some embodiments, the high-pass filter and the low-pass filter have a common cutoff frequency.

In some embodiments, the cutoff frequency is approximately 600 Hz.

Various embodiments of the present disclosure relate to a method for training a keyword classifier for imposter rejection in a wearable device, the method comprising generating positive training data, the positive training data comprising speech samples wherein both the high-frequency and low-frequency components of a spoken keyword are present in the speech samples; generating negative training data, the negative training data comprising speech samples with only the high-frequency component of the spoken keyword are present in the speech samples; and training a classification model using the positive training data and the negative training data; wherein the trained classification model rejects a keyword spoken by a non-wearer of the wearable device.

In some embodiments, the negative training data is first negative training data, the method further comprising generating second negative training data, the second negative training data comprising speech samples that do not comprise the keyword.

In some embodiments, generating the positive training data comprises processing a keyword speech sample to extract the high-frequency component and to extract the low-frequency component, wherein the high-frequency component and the low-frequency component are combined to generate the positive training data.

In some embodiments, the low-frequency component is processed by an equalizing circuit to change the amplitude of one or more frequency bands in the low-frequency component prior to combining the low-frequency component with the high-frequency component.

### BRIEF DESCRIPTION OF THE DRAWINGS

FIG. 1 is a block diagram of a speech recognition system, according to some embodiments.

FIG. 2 is a block diagram of a keyword-recognition system, according to some embodiments.

FIG. 3 is a flow diagram of a method for keyword recognition, according to some embodiments.

FIG. 4 is a block diagram of a training system for a classification model, according to some embodiments.

FIG. 5 is a flow diagram of a method for training a classification model for imposter rejection, according to some embodiments.

### DETAILED DESCRIPTION

Referring generally to the figures, methods and apparatuses for a speech recognition system with improved imposter rejection are disclosed. The embodiments of the present disclosure may be included in, communicate with, or otherwise configured with an automatic speech recognition (ASR) system to decode commands or speech given by the user. ASR systems are generally known to translate audio streams into text or commands, and may employ various acoustic models, language models, lexicons, and/or grammar models. For example, an ASR system may utilize an acoustic engine to convert audio data into a sequence of phonemes or graphemes, and a decoder to convert the phonemes or graphemes into words and phrases. Some ASR systems may employ a trigger module wherein a user is required to speak a trigger keyword prior to giving a command, and wherein the trigger module is configured to recognize the trigger keyword and send a control signal to other components of the ASR system responsive to the detected keyword. However, it is desirable that the ASR system responds only when the user of the ASR system speaks the trigger keyword and command.

The various methods and apparatuses provide advantageous form and function of a wearable device for suppressing the influence of speech from non-wearers of the device (used interchangeably with imposter and unassociated person or speaker), which can be used specifically for a trigger keyword or command detection in ASR systems. The wearable device may generally include a microphone and a vibration sensor, where the microphone measures the audio from the air and the vibration sensor measures vibrations from the body of the wearer. The systems and methods may also use a classifier that analyzes the output of the microphone and the vibration sensor to detect keywords spoken by a wearer of the device and reject trigger keywords or commands spoken from non-wearers of the device. Herein, it should be understood that a keyword can refer to any spoken word or phrase with a significance in an ASR system. For example, a keyword could be a trigger keyword for a trigger module, or a command the ASR system is configured to recognize and/or respond to. As will become apparent in the subsequent figures and details, the measurement of a speech signal using the microphone and the vibration sensor along with a trained classifier provide an improved trigger mechanism in ASR systems. Similarly, the systems and methods herein can be used to improve other trainable models in an ASR system, such as an acoustic model for grapheme recognition.

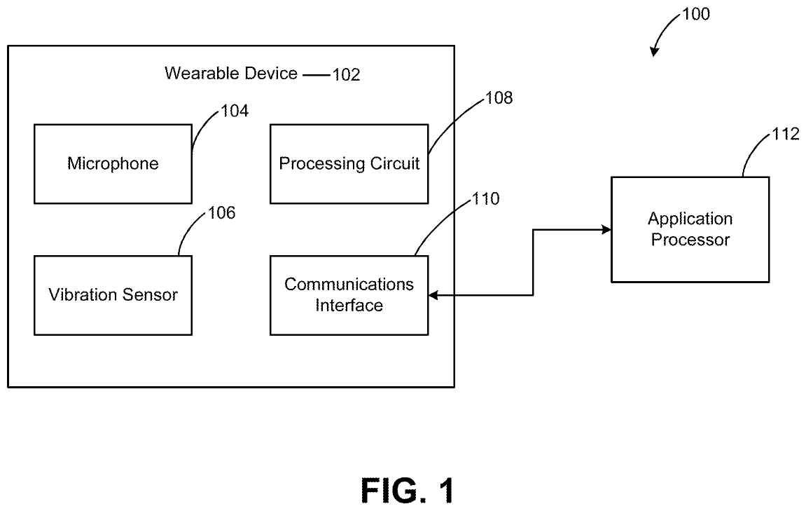

Referring to FIG. 1, a speech recognition system 100 is shown. Speech recognition system 100 is shown to include a wearable device 102 and an application processor 112. Wearable device 102 is worn by a user (used interchangeably with wearer, intended user, and associated user) and is communicably coupled to the application processor 112 via communications interface 110. Speech recognition system 100 is generally configured to process speech data measured by the wearable device 102 and determine a command spoken by the user.

In preferred embodiments, wearable device 102 is designed to be worn on or near the head of the user. For example, the wearable device 102 may be designed to fit on, in, or near one or both ears of the user. It should also be appreciated that the components of wearable device 102 may be implemented as multiple, separate devices suitable to perform the functions described herein, where the multiple, separate devices may or may not be worn by a user.

Wearable device 102 includes a microphone 104 that is generally configured to measure acoustic signals from the environment of the wearable device 102. In some embodiments, the microphone 104 is configured outward away from the user's body to capture acoustic signals that pass through the air. Microphone 104 may be configured with directionality to focus the measurement on acoustic signals from the user. Microphone 104 may be one or more audio capture devices configured within wearable device 102 that could include for example, any combination of micro electrical-mechanical systems (MEMS), diaphragm-based sensor, piezoelectric elements, or any other acoustic sensor.

Wearable device 102 also includes vibration sensor 106 that is generally configured to measure bone or tissue vibration signals from the user. In various embodiments, the vibration sensor 106 is configured to rest on, within, or near the ear canal of the user to measure the vibration signals. In some embodiments, the vibration sensor 106 is configured to rest on the outside of the head of the user, such as the directly over mastoid process or other part of the skull near the ear. Vibration sensor 106 can include one or more sensors such as, but not limited to, piezoelectric elements, piezo-resistive elements, accelerometers, MEMS devices, gyroscopes, laser velocity or laser displacement systems, or any other type of transducer which can sense vibrations on the body's surface that are associated with vocalization; and any combination thereof. Vibration sensor 106 may be rigidly attached to or otherwise reinforced on the wearable device 102 to reduce vibration noise.

Wearable device 102 can also include a processing circuit 108. Processing circuit 108 may include any number of analog or digital circuit components, such as resistors, capacitors, inductors, amplifiers, filters, equalizers, analog-to-digital converters, and others to process the various signals received from the microphone 104 and the vibration sensor 106. Filters may include high-pass filters and low-pass filters, which can be characterized by a designed cutoff frequency (used interchangeably with crossover frequency and corner frequency). Filters may also include band-pass and band-reject filters characterized by a desired frequency band of an input signal to pass or reject, respectively. A filter may be configured as an analog filter with any combination of circuit components, or as digital filter according to any known algorithm. Filters may be implemented as any order of filter to meet a desired design constraint.

Processing circuit 108 may also include a general purpose processor, one or more microprocessors, a digital signal processor, an application specific integrated circuit (ASIC), one or more field programmable gate arrays (FPGAs), a group of processing components, or other suitable electronic processing components to perform processing of data received from the microphone 104 and vibration sensor 106. In some embodiments, processing circuit 108 includes a digital signal processor (DSP). Processing circuit 108 may have one or more storage devices that store instructions thereon that, when executed by one or more processors, cause the one or more processors to facilitate the various processes described in the present disclosure. The one or more storages devices may include random access memory (RAM), read-only memory (ROM), hard drive storage, temporary storage, non-volatile memory, flash memory, optical memory, or any other suitable memory for storing software objects and/or computer instructions. Processing circuit 108 may be configured to dynamically receive processing instructions, configuration files, or machine code from application processor 112 to determine processes to be performed by processing circuit 108.

Communications interface 110 may be any communications interface, which may include, for example, wired or wireless interfaces (e.g., jacks, antennas, transmitters, receivers, transceivers, wire terminals, etc.) for conducting data communications with various systems, devices, or networks. For example, the one or more communications interfaces may include a Bluetooth module and antenna for sending data to and receiving data from the application processor 108 via a Bluetooth-protocol network. As another example, the communications interfaces may include an Ethernet card and port for sending and receiving data via an Ethernet-based communications network or a WiFi transceiver for communicating via a wireless communications network. Further still, the communications interface 110 may include a radio transmitter communication system. The one or more communications interfaces may be configured to communicate via local area networks or wide area networks (e.g., the Internet, a building WAN, etc.) and may use a variety of communications protocols.

Wearable device 102 may also include a power supply, which may be implemented as a battery or charge capacitor to power the components of the wearable device 102. In some embodiments, the components of wearable device 102 may be designed to reduce power consumption of the wearable device 102 so reduce the size or cost of the power supply. Wearable device 102 may also be configured to operate in an always-on configuration such that a continuous stream of speech signals can be analyzed for a trigger keyword and/or command.

Still referring to FIG. 1, application processor 112 may be configured to receive audio or speech data from the wearable device 102. Application processor 112 can include any of a general purpose processor, one or more microprocessors, a digital signal processor, an ASIC, one or more FPGAs, a group of processing components, DSP, or other suitable electronic processing components. Application processor 112 may have one or more storage devices that store instructions thereon that, when executed by one or more processors, cause the one or more processors to facilitate the various processes described in the present disclosure. The one or more storages devices may include RAM, ROM, hard drive storage, temporary storage, non-volatile memory, flash memory, optical memory, or any other suitable memory for storing software objects and/or computer instructions. Application processor 112 is configured with a communication interface to communicate with wearable device 102. Application processor 112 may also be configured to dynamically receive data or software from a networked system via a network interface, which could be a wired or wireless interface that may facilitate communication via a local area networks or wide area networks (e.g., the Internet, a building WAN, etc.) and may use a variety of communications protocols.

Application processor 112 may be implemented in the wearable device 102 or in a device associated with the wearable device 102. The associated device could be, for example, a cell phone, computer, laptop, tablet, smart watch, or other device. Application processor 112 may be configured to receive any of unprocessed or processed acoustic data, unprocessed or processed vibration data, control signal, or other signal from the wearable device 102. It should be appreciated that any feature, function, or component of processing circuit 108 may be implemented within application processor 112 or within the associated device with application processor 112. Similarly, any feature, function, or component discussed in relation to application processor 112 may be implemented by processing circuit 108 or within wearable device 102. In some embodiments, application processor 112 and processing circuit 108 are implemented as the same circuit.

Speech recognition system 100 may be configured to communicate with and/or implement a distributed ASR system. For example, various components of an ASR system may be executed across the processing circuit 108 and application processor 112. In some embodiments, ASR is completely executed on processing circuit 108, wherein the decoded text or commands are sent to the application processor 112. In some embodiments, the ASR system is executed entirely on the application processor 112, wherein the processing circuit 108 sends the filtered or unfiltered signals from the microphone and vibration sensor. In some embodiments, signal processing and keyword identification are executed by processing circuit 108, and processing circuit 108 sends a control signal indicating the keyword and/or the processed speech signal to application processor 112 for decoding. As will be appreciated by one skilled in the art, the features, configurations, and functions of the components discussed hereinafter can be implemented by either the processing circuit 108, the application processor 112, or distributed across the two processing systems in any combination to achieve the keyword recognition system of the present application.

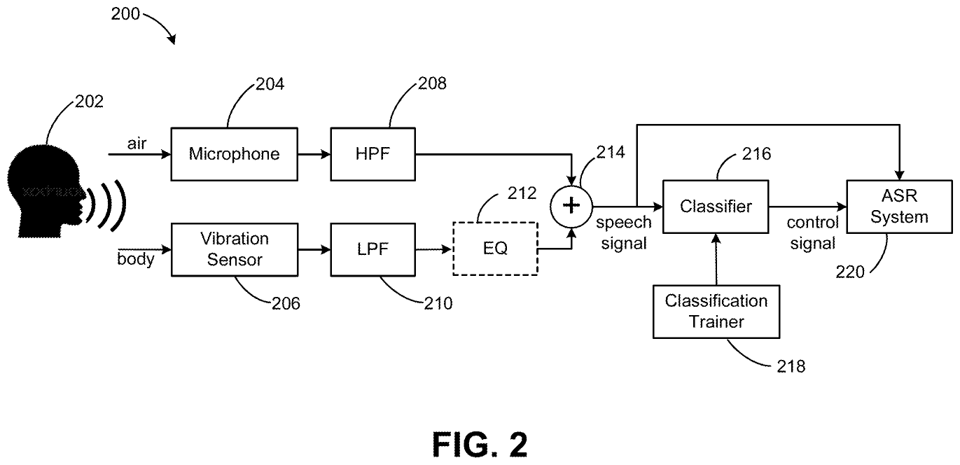

Referring now to FIG. 2, a diagram for a keyword recognition system 200 is shown. System 200 may be implemented in the wearable device 102 or distributed across speech recognition system 100. System 200 is generally used to determine whether a wearer 202 of a wearable device spoke a keyword. The trigger keyword can be any pre-determined word or phrase. In some embodiments, the system 200 may be configured to recognize multiple trigger keywords. In some embodiments, system 200 can be configured to dynamically change the trigger keyword depending on a context or state of the system 200. The wearable device may be understood to comprise a microphone 204 and a vibration sensor 206. The microphone 204 may be configured to measure acoustic signals from the environment near wearer 202, which may inadvertently include signals from non-wearers, other electronic devices, and environmental noise. Vibration sensor 206 is configured to measure vibrations from the body of the wearer 202, wherein speech signals can be resonate through bone or tissue of the wearer 202 while the wearer 202 is speaking. Speech signals can then be input into classifier 216 and/or other speech processing systems, such as ASR system 220.

A speech signal may be measured by both the microphone 204 and the vibration sensor 206. Data from the microphone 204 and vibration sensor 206 may be associated with each other by a processing circuit of speech processing 200. For example, acoustic data from the microphone 204 and vibration data from vibration sensor 206 may each include a time stamp associated with the data. In some embodiments, a delay circuit may be included to offset differing time-delays in acquisition or processing of data from the microphone 204 or vibration sensor 206. Generally, the vibration sensor 206 receives signals with lower frequencies than signals received by microphone 204. In some embodiments, as will be discussed herein, audio signals from the microphone 204 and vibration signals from the vibration sensor 206 may be processed before input into the classifier 216, such as high-pass filter 208, low-pass filter 210, and equalizer 212. As will become apparent, processing by high-pass filter 208, low-pass filter 210, and equalizer 212 may further distinguish the frequency components of the vibration signal and the audio signal for classification.

Acoustic data from microphone 204 may be processed by the high-pass filter 208 to generate a high-frequency signal. The high-frequency signal can be isolated to remove low-frequency noise in the microphone. In some embodiments, the high-pass filter is configured as a band-pass filter, such that both low-frequency noise and ultra-high-frequency noise can be removed from the acoustic signal, and only a high-frequency signal is isolated. In some embodiments, the high-pass filter 208 is characterized by a set of parameter coefficients. The corner frequency (or corner frequencies) of the high-pass filter 208 may be fixed or adaptive. The corner frequency may be adaptive depending on characteristics of the voice the specific wearer 202. The corner frequency may be chosen to maximize a signal-to-noise ratio (SNR) of the high-frequency signal. The high-frequency component of the acoustic signal may be isolated since microphones can easily measure the high-frequency speech signals.

Vibration data from vibration sensor 206 may be processed by the low-pass filter 210 to generate a low-frequency signal. Vibration signals are low-pass filtered to remove high-signal noise. In some embodiments, the low-pass filter is implemented as a band-pass filter, such that both ultra-low-frequency noise and high-frequency noise are removed from the vibration signal, and only the low-frequency signal is isolated. In some embodiments, the low-pass filter 210 is characterized by a set of parameter coefficients. The corner frequency (or corner frequencies) of the low-pass filter 210 may be fixed or adaptive. The corner frequency may be adaptive depending on characteristics of the voice the specific wearer 202. The corner frequency may be chosen to maximize the SNR of the high-frequency signal. The low-frequency component of the vibration signal may be isolated since the body transmits low-frequency signals better than high-frequency signals.

Herein, high-frequency and low-frequency may be understood to mean relatively high and relatively low frequency components, respectively, within the human auditory range or within the human-speech frequency range. Ultra-low-frequency may be understood to mean frequencies below the human auditory range or human speech frequency range, while ultra-high frequency may be understood to mean frequencies above the human auditory range or human speech frequency range. In some embodiments, the high-pass filter 208 and low-pass filter 210 are coupled such that the filters 208 and 210 share a common cutoff frequency or approximately the same cutoff frequency, such that a full-spectrum speech signal can be reconstructed. In some embodiments, the shared cutoff frequency is approximately 600 Hz. In various embodiments, the cutoff frequencies for the high-pass filter 208 and low-pass filter 210 may be between 300 Hz to 3 kHz. In some embodiments, the cutoff frequency is chosen based on a signal-to-noise ratio (SNR) of an output of the high-pass filter 208 and the SNR of an output of the low-pass filter 210. For example, the SNR of the high-pass output may be compared to the SNR of the low-pass output, and the cutoff frequency is determined based on a frequency in which the SNR of the high-pass output exceeds the SNR of the low-pass output. In some embodiments, the cutoff frequencies are chosen based on cutoff frequencies used in training data of the classifier 216. For example, the cutoff frequencies of high-pass filter 208 and low-pass filter 210 are set to the same cutoff frequencies of the training data. In another example, the cutoff frequencies of high-pass filter 208 and low-pass filter 210 are chosen to be higher than the cutoff frequencies used in the training data. In some embodiments, the cutoff frequency of the high-pass filter 208 and low-pass filter 210 may be chosen to exclude a mid-frequency component of the speech signal that does not contain meaningful data.

In some embodiments, the filtered vibration data is further processed by an equalizer 212. Vibrations with different frequencies may be attenuated by the body differently. Equalizer 212 generally executes a set of equalization processes to match the voice-band frequency response of the vibration signal to that of the microphone 204. Equalization may include filtering the signal to adjust the gain of various frequency bands in the low-frequency signal. Equalizer 212 may be defined by a set of filter coefficients, where the coefficients may be generic or user-specific. User-specific equalization may be based on a specific speaker's voice characteristics, and may be generated during a device setup procedure for each user, such as a device-prompted speech or general voice identification. Equalizer 212 may be noise adaptive, wherein the filter coefficients change per different noise conditions. In some embodiments, equalizer 212 may be scenario adaptive, wherein the filter coefficients change depending on an operation state, such as a communication or voice-recording mode, where better voice quality is preferred, or a voice command mode improved speech-recognition accuracy is preferred. The filter coefficients of equalizer 212 may be generated by and received from an application processor to be loaded onto an edge processor executing equalizer 212.

After processing, the low-frequency signal and high-frequency signals can be input into a classifier 216 that determines whether the wearer 202 spoke a trigger keyword. In some embodiments, the low-frequency signal and the high-frequency signals are combined at 214 into a single speech signal prior to input into classifier 216. In some embodiments, time-domain or frequency-domain features of the low-frequency signal and the high-frequency signal, or of the combined speech signal, are extracted as inputs into the classifier 216. The classifier 216 may use a trained classification model. The classification model may be a machine learning model, such as, but not limited to, a neural network, decision tree, nearest neighbor, or a support vector machine. In some embodiments, classification model 216 is a finite state transducer. In some embodiments, the classifier 216 is a trigger module, wherein the recombined speech signal is treated as an input speech signal, and the trigger module is specifically configured to reject keywords without the low-frequency component of the keyword. In some embodiments, classifier 216 is a command recognition module, wherein the keyword is a command word or phrase, and wherein the classifier 216 determines whether the command word or phrase was spoken by the wearer of the device.

In some embodiments, classifier 216 may be configured to analyze the input speech signal in discrete frames or groups. Accordingly, keyword-recognition system 200 may include a buffer to load in the speech signal for analysis as a discrete frame or group. The discrete group may be used for feature extraction for input into the classifier, such as a Fourier transform. The discrete grouping may be structure in a circular buffer, wherein the most recently captured data point is added to the buffer and the oldest data point is removed, such that discrete groups of data points can be continually analyzed.

The classifier 216 may be configured to output an indication whether a keyword was spoken by the wearer 202 of the device. The output may be a stream of binary indications (e.g., a two-class classifier), such as a stream of bits. In some embodiments, the classifier 216 is a three-class classifier, wherein the classifier 216 determines if the wearer 202 spoke the keyword, a non-wearer spoke the keyword, or if no keyword was detected. In some embodiments, the classifier 216 is configured as a non-deterministic classifier, wherein a probability of whether the wearer 202 spoke the keyword is output by the classifier. In some embodiments, the output is associated with a time stamp indicating a point in time in which the keyword was spoken, or a point in time in which a potential command may follow the spoken keyword. The classifier 216 may be configured to send a control signal to a processing device executing an ASR system 220 responsive to the output of classifier 216 indicating the wearer of the wearable device spoke the keyword. The control signal may be a wake up signal to indicate the ASR system 220 should expect and process a potential command, and may include the timestamp of when the keyword was spoken or when a potential command can be expected.

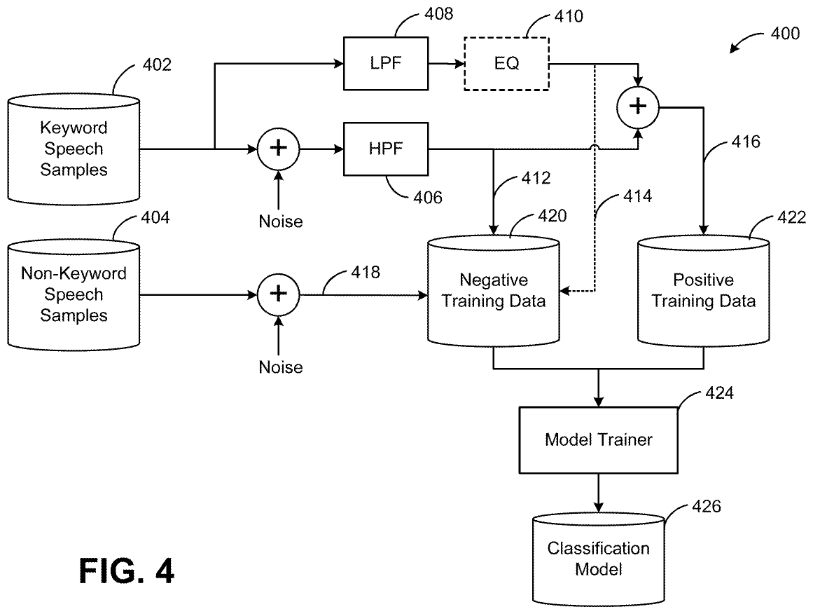

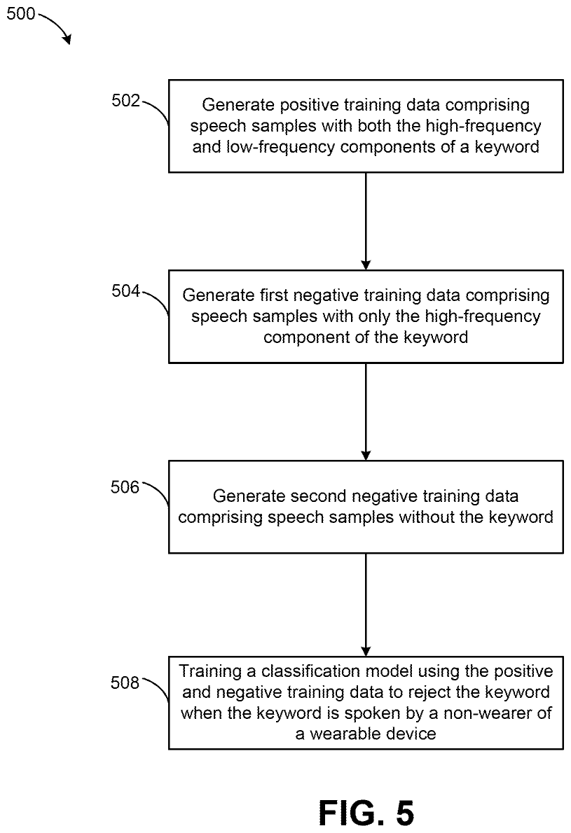

Classifier 216 can be trained, compiled, or otherwise configured by classifier trainer 218. Classifier trainer 218 may generally generate or receive training data to train the classifier 216. For example, classifier trainer 218 may be configured to measure an error rate of a classification model of classifier 216, and adjust one or more parameters of the classification model based on the error rate of the model. Classifier trainer 218 may be implemented in a processing circuit separate from the classifier 216. Implementations of classifier trainer 218 will be discussed in greater detail in relation to FIG. 4-5.

In some embodiments, the processed speech signal generated at 214 can be sent directly into the ASR system 220. ASR system 220 may be configured with one or more trainable models, such as an acoustic model or language model. The processed speech signal generated at 214 may be input into one or more of these trainable models for improved speech recognition. For example, the speech sample may be input into an acoustic model configured to generate a stream of graphemes detected from a speech signal. The acoustic model may be trained or otherwise configured to only detect graphemes spoken by the wearer of the wearable device and reject imposter influence using the processed speech signal from 214. As will be appreciated, the one or more trainable models of the ASR system 220 may also have associated model trainers, wherein the model trainer can be configured to train the trainable model using speech signals processed according to keyword-recognition system.

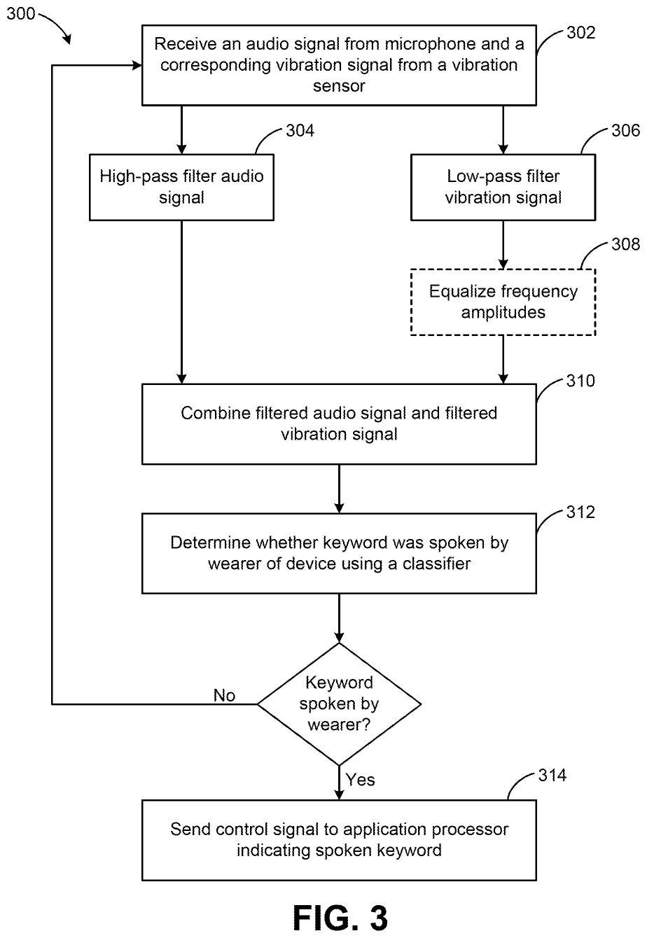

Referring to FIG. 3, a method 300 for implementing keyword recognition with imposter rejection is shown. Method 300 generally measures a speech signal using a microphone that measures speech transmitted in the air and a vibration sensor that measures vibrations from the body of the wearer, filters the speech signal for specific frequency components, and inputs the modified speech signal into a classifier. The classifier determines whether a wearer of a device implementing the method 300 spoke the keyword, and can be trained to reject keywords spoken by a non-wearer of the device. The keyword may be a word or phrase, and may be a trigger keyword or a command. Method 300 may be executed by keyword-recognition system 200 or a processing device of speech recognition system 100.

At 302, an acoustic signal is received from the microphone and a vibration signal is received from the vibration sensor. The microphone may be configured to measure the acoustic signal from the air around the wearer. The vibration sensor may be configured to measure vibrations from the body of the wearer. The acoustic signal and vibration signal may be generally be associated with the same speech signal. In some embodiments, the acoustic signal and the vibration signal are associated with a timestamp. In some embodiments, the acoustic signal and the vibration signal are time-phase shifted to align the signals in time.

In some embodiments, a high-frequency component of the acoustic signal is isolated at 304. The acoustic signal may be processed by a high-pass filter, which may be an analog filter or a digital filter implemented on hardware components or by a software algorithm. The high-frequency component and high-pass filter may be characterized by a corner frequency. In some embodiments, the high-pass filter is configured as a band-pass filter, such that both low-frequency noise and ultra-high-frequency noise can be removed from the acoustic signal, and only a high-frequency signal is isolated. The corner frequency (or corner frequencies) of the high-pass filter 208 may be fixed or adaptive. The corner frequency may be adaptive depending on characteristics of the voice the specific wearer. The corner frequency may be chosen to maximize a signal-to-noise ratio (SNR) of the high-frequency signal.

In some embodiments, a low-frequency component of the vibration signal is isolated at 306. The vibration signal may be processed by a low-pass filter, which may be an analog filter or a digital filter implemented on hardware components or by a software algorithm. The low-frequency component and low-pass filter may be characterized by a corner frequency. The corner frequency may be the same or nearly the same as the corner frequency of the high-frequency component. In some embodiments, the low-pass filter is implemented as a band-pass filter, such that both ultra-low-frequency noise and high-frequency noise are removed from the vibration signal, and only the low-frequency signal is isolated. The corner frequency (or corner frequencies) of the low-pass filter 210 may be fixed or adaptive. The corner frequency may be adaptive depending on characteristics of the voice the specific wearer. The corner frequency may be chosen to maximize the SNR of the high-frequency signal.

In some embodiments, the filtered vibration signal is optionally equalized at 308 prior to step 310. The filtered vibration signal may be processed by an equalizer. Equalization generally matches the voice-band frequency response of the vibration signal to that of the microphone. Equalization may amplifies or attenuates various frequency bands of the signal. Equalization may be fixed or adaptive. An adaptive equalizer may enable the frequency-specific gains to be changed over time responsive to the received signal or to a given speaker. Speaker-specific equalization may be based on a specific speaker's voice characteristics.

At 310, the audio signal from the microphone and the vibration signal from the vibration signal (or in some embodiments, the high-frequency component and the low-frequency component) are combined into a speech signal. In some embodiments, the highest frequency of the low-frequency component is the same or nearly the same frequency as the lowest frequency of the high-frequency component, such that the combined speech signal at 310 is a full spectrum speech signal. Feature extraction may be performed prior to input into a classifier at 312. Feature extraction could include analysis of time-domain or frequency-domain features of the high-frequency component and low-frequency component, or of the combined speech signal. Extracted features may be used in addition or alternative to the actual data signals for input into the determination step at 312.

At 312, a determination is made whether the wearer of the device spoke a trigger keyword, the determination being made using the processed acoustic signal and the processed vibration signal. The determination may be made by inputting the individual signals or the combined speech signal into a classifier, wherein the classifier is configured to detect keywords spoken by the wearer of the device and reject keywords spoken by non-wearers of the device. The determination may be made using a classification model, which may be a machine learning model or finite state transducer as discussed herein. The classification model may be trained using positive and negative training data.

Responsive to a determination at 312 that the wearer did not speak the keyword, the method 300 repeats at 302 to continue processing acoustic and vibration data streams. Responsive to a determination at 312 that the wearer did speak the keyword, a control signal is sent at 314 indicating the keyword was spoken by the wearer. The control signal may be sent to a processing device configured to analyze the acoustic data for a command, such as an ASR system. The control signal may be a wake up signal to turn on electrical components in a power-saving state to begin processing a speech signal. The speech signal may be the original microphone signal, or the combined speech signal from 310.

Referring now to FIG. 4, a training system 400 for training a classification model for an imposter-rejection classifier is shown. Training system 400 may be implemented by classifier trainer 218 or by one or more processing devices of speech-recognition system 100. The training system 400 may be configured to train the classifier 216 of the keyword-recognition system 200 for a wearable device 102. The classification model may be trained to accept keywords spoken by a wearer of the wearable device 102 and reject keywords spoken by a non-wearer of the wearable device 102. Training data may generally include a speech or audio sample, and a label. Training data should be labeled as positive for speech samples with a keyword spoken by an intended user and negative for speech samples with a keyword spoken by an imposter or unassociated person or device, as well as for speech samples where no keyword was spoken. Similarly, training data can be generated in a similar way for training other models in an ASR system, such as an acoustic model, to detect speech features spoken by the wearer and reject features from non-wearers of the device.

Training system 400 is shown to include keyword speech samples 402 and non-keyword speech samples 404. In some embodiments, speech samples 402 and 404 are received from a networked server or other processing circuit that maintains the training data. In some embodiments, speech samples 402 and 404 are generated using an implementation of keyword-recognition system 200 by a user speaking the command. Speech samples in databases 402 and 404 may be a single word, a single phrase, or a sample of continuous speech with several words and phrases. Samples may be spoken by various speakers, and be varied in intonation, pitch, volume, and duration, for example. Accordingly, keyword speech samples 402 include speech samples where the keyword is spoken, and non-keyword speech samples 404 include speech samples with any number of words except the keyword, and may include speech samples with no spoken words at all. In keyword speech samples 402, the keyword may be spoken at any part of the speech sample, e.g., the beginning, middle, or end, for example, and be preceded and/or followed by other non-keyword words. Samples from keyword speech samples 402 and non-keyword speech samples 404 can be sampled according to any sampling method, such as, but not limited to, random sampling or model-error sampling.

Samples from keyword speech samples 402 and non-keyword speech samples 404 can be combined with a noise signal prior to processing. Noise signals could include background noise, white noise, or background speech. Noise signals may be chosen to simulate various environments that a wearable device may be used in. In some embodiments, the speech samples form keyword speech samples 402 and non-keyword speech samples 404 may be passed through various filters to induce noise in the signal. By incorporating noise in the speech samples, the classification model can be trained with a larger variety of training data to more robustly recognize the keyword in noisy environments.

The keyword speech samples 402 and the non-keyword speech samples 404 can be processed in a variety of ways prior to labelling the speech samples for training. To create positive training data 416, the keyword speech samples are processed to simulate being spoken by the wearer of the wearable device. A keyword speech sample from keyword speech samples 402 can be filtered to extract the low-frequency component of the speech sample at 408 and the high-frequency component of the speech sample at 406. The high-pass filter 406 can be configured the same as any filter discussed herein, such as the high-pass filter 208 of keyword-recognition system 200, and the low-pass filter 408 can be configured the same as any low-pass filter discussed herein, such as low-pass filter 210. Additionally, in some embodiments, the low-frequency component of the speech sample can be processed by an equalizer 410 to balance the amplitudes of frequency bands in the low-frequency signal to produce more natural sounding speech. The equalizer 410 can be configured the same as any equalizer discussed herein, such as equalizer 212. The low-frequency component and the high-frequency component can be combined into the speech sample 416 and stored in positive training data 422.

In some embodiments, positive training data can in addition or alternative be generated by storing and labelling the keyword speech samples 402 as keyword samples in positive training data 422 without processing the speech samples with high-pass filter 406 and low-pass filter 408.

Speech samples from keyword speech samples 402 can also be used to generate speech sample 412 for negative training data. Speech sample 412 can be generated by extracting or isolating the high-frequency component of a keyword speech sample at 406 but not combining the high-frequency component with the low-frequency component. Speech sample 412 can also be combined with a noise signal as discussed herein prior to storing the speech sample 412 in negative training data 420. By not combining speech sample 412 with the low-frequency component, the speech sample 412 simulates the non-wearer of the wearable device speaking the keyword since the vibration sensor may not measure an associated vibration signal (low-frequency component).

In some embodiments, negative training data may also be generated from processed speech samples 414 and stored in negative training data 420. Speech samples 414 generally include the low-frequency component of the keyword, but lack a high-frequency component. Speech samples 414 may be used in training to prevent the classification model from solely associating the low-frequency component of the keyword with a positive classification, such that both the high-pass and the low-pass components must be present to indicate a positive classification.

Additionally, speech samples from non-keyword speech samples 404 can be used to generate speech sample 418 for negative training data. Speech sample 418 can be any non-keyword speech sample as discussed herein, or an audio sample with no spoken words. Speech sample 418 can be stored in negative training data 420 for training the classifier. Non-keyword training data can be used to train the classification model with speech samples with low-frequency components that are not the keyword such that the classification model does not erroneously associate any low-frequency component with the keyword. Although not shown, speech samples form the non-keyword speech samples 404 can be filtered and processed according to any known method to further vary the training data.

In some embodiments, negative training data 420 and positive training data 422 are stored as a single database, wherein the speech samples in the negative training data 420 are stored with or otherwise associated with a negative label in the single database, and the speech samples of the positive training data 422 are stored with or otherwise associated with a positive label in the single database.

In some embodiments, positive and negative training data can be received from a database of pre-processed speech samples, wherein the speech samples are measured using the wearable device 102 and keyword-recognition system 200. The pre-processed speech samples may be more similar to the actual speech signals that will be processed by the classifier 216 in execution of keyword-recognition system 200, and accordingly can be used to train classifier 216 to more accurately recognize the keywords and reject keywords from imposters.

The negative training data 420 and the positive training data 422 may be used by a classification trainer 424 to train a classification model 426. The classification model 426 may be any classification model discussed herein, such as, but not limited to, a machine learning model (e.g., neural network, decision tree, nearest neighbor, vector model) or finite-state transducer. Classification trainer 424 can be configured to train classification model 426 according to any known means to train the specific type of classification model 426. For example, the classification trainer 424 may be configured to extract time-domain or frequency-domain features of the training data for input into the classification model. The classification trainer 424 may also be configured to measure an error rate of the classification model and adjust one or more parameters of the classification model based on the measured error rate. Classification trainer 424 may be configured to sample the negative training data 420 and the positive training data 422 according to any sampling method.

Referring to FIG. 5, a method 500 for training a keyword classification model for imposter rejection is shown. Method 500 may be implemented by training system 400. Method 500 is generally implemented to generate various training data for a classification model and to train the classification model to reject spoken keywords from an imposter. The classification model can be used to process speech samples measured by a wearable device, wherein only keywords spoken by a wearer of the wearable device are accepted, and spoken keywords from a non-wearer of the device are not accepted. The classification model can be any classification model discussed herein. Method 500 can also be used to generate training data for and train other models in an ASR system, such as an acoustic model, to detect speech features spoken by the wearer and reject features from non-wearers of the device.

At 502, positive training data is generated. Positive training data includes speech samples that simulate being spoken by the wearer of the wearable device. Speech samples for positive training data generally include both the low-frequency component and the high-frequency component of a spoken keyword. In some embodiments, the positive training data may be speech samples generated by the keyword-recognition system 200, wherein the wearer of the wearable device speaks the keyword in a speech signal. In some embodiments, positive training data may be generated using a high-pass filter to isolate a high-frequency component of the keyword speech samples and a low-pass filter to isolate a low-frequency component and subsequently combined, as discussed in relation to training system 400 for example. In some embodiments, the low-frequency component may also be processed by an equalizing circuit, as also discussing in relation to training system 400. Speech samples may also be combined with a noise signal or passed through a noise filter to vary the conditions in which the keyword is spoken by the wearer of the device.

At 504, first negative training data can be generated for training a classification model. The first negative training data can include speech samples of a keyword simulated to be spoken by a non-wearer of the device. In one implementation, a keyword speech sample is high-pass filtered to remove the low-frequency component, and consequently labelled as a negative data sample. By high-pass filtering the keyword, the training sample simulates a keyword spoken by a non-wearer wherein the keyword is received at the microphone of the wearable device, but is not detected by the vibration sensor. The keyword signal may be high-pass filtered The high-passed filtered keyword can also be combined with a noise signal or passed through a noise filter as discussed herein to vary the conditions in which the keyword is spoken by the non-wearer.

At 506, second negative training data can optionally be generated. The second negative training data can include any speech signal that is not the keyword. For example, negative training data may be a noise signal. A noise signal could be an audio sample without any spoken words, or a speech sample with any word or words other than the keyword. The word or phrase may be spoken by the wearer of the device, or may be spoken by a non-wearer of the device. Any other noise may be added to the non-keyword speech signal, such as white noise, background noise, or unnatural noise. In some embodiments, the second negative training data is generated using measurements from the wearable device in online operation. In some embodiments, additional negative training data may be generated comprising the low-frequency component of the keyword but lacking the high-frequency component.

At 508, the classification model is trained using the positive training data, the first negative training data, and optionally the second negative training data. The classification model can be trained to reject keywords spoken by a non-wearer of the device. Training the classification model 508 can include any training method. In some embodiments, training the classification model at 508 includes extracting time-domain or frequency-domain features from the training data for input into the classification model. Training the classification model at 508 may also include a sampling function to sample the training data according to any sampling method. Training the classification model may include measuring an error rate of the model and adjusting one or more parameters of the model based on the measured error rate. The trained classification model may be sent to a processing circuit to be used in a keyword-recognition system.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method for keyword recognition in a wearable device, the method comprising:
generating an audio signal from a spoken word detected by a microphone;
generating a vibration signal from the spoken word detected by a vibration sensor, the vibration signal having a frequency component below frequencies of the audio signal; and
determining whether a keyword was spoken by a wearer of the wearable device based on the audio signal and the vibration signal, wherein the keyword is rejected responsive to a determination the keyword was not spoken by the wearer of the wearable device.

2. The method of claim 1, wherein generating the audio signal includes filtering an output of the microphone using a high-pass filter and generating the vibration signal includes filtering the output of the vibration sensor using a low-pass filter, the method further comprising combining the audio signal and the vibration signal prior to determining whether the keyword was spoken by the wearer.

3. The method of claim 2, wherein generating the vibration signal further comprises processing the low-frequency component of the vibration signal with an equalizer.

4. The method of claim 2, wherein the high-pass filter and the low-pass filter have a common cutoff frequency.

5. The method of claim 4, wherein the cutoff frequency is approximately 600 Hz.

6. The method of claim 1, wherein determining whether a keyword was spoken by the wearer of the wearable device further comprises using a classification model.

7. The method of claim 6, wherein the classification model is trained using a negative training set comprising speech samples simulating non-wearers of the device.

8. The method of claim 1, wherein the keyword is a trigger keyword, the method further comprising sending a control signal to a processing circuit responsive to the determination the keyword was spoken by the wearer.

9. A wearable apparatus comprising:
a microphone configured to measure acoustic signals from the air;
a vibration sensor configured to measure vibration signals from the body of a user of the apparatus; and
a classifier configured to:
receive a first signal from the microphone and a second signal from the vibration sensor, the second signal comprising frequencies below frequencies of the first signal;
combine the first signal and the second signal to generate a processed speech signal; and
determine whether a keyword was spoken by the user of the apparatus based on the processed speech signal.

10. The apparatus of claim 9, wherein the apparatus is a device configured to be worn in or near the ear of the user.

11. The apparatus of claim 10, wherein the vibration sensor is configured to measure vibrations from the inside of the ear of the user.

12. The apparatus of claim 9 further comprising:
a high-pass filter coupled to an output of, and configured to process signals from, the microphone;
a low-pass filter coupled to an output of, and configured to process signals from, the vibration signal; and
a digital signal processor implementing classification of the processed speech signal.

13. The apparatus of claim 12, further comprises an equalizer, the equalizer coupled to the output of, and configured to process signals from, the low-pass filter, wherein the equalizer changes the amplitude of one or more frequency bands in the second filtered signal.

14. The apparatus of claim 12, wherein the digital signal processor is configured to send a control signal to an application processor responsive to a determination the keyword was spoken by the user of the apparatus.

15. The apparatus of claim 12, wherein, the high-pass filter and the low-pass filter have a common cutoff frequency.

16. The apparatus of claim 15, wherein the cutoff frequency is approximately 600 Hz.

17. A method for training a keyword classifier for imposter rejection in a wearable device, comprising:
generating positive training data, the positive training data comprising speech samples wherein both the high-frequency and low-frequency components of a spoken keyword are present in the speech samples;
generating negative training data, the negative training data comprising speech samples with only the high-frequency component of the spoken keyword are present in the speech samples; and
training a classification model using the positive training data and the negative training data;
wherein the trained classification model rejects a keyword spoken by a non-wearer of the wearable device.

18. The method of claim 17, wherein, the negative training data is first negative training data, the method further comprising generating second negative training data, the second negative training data comprising speech samples that do not comprise the keyword.

19. The method of claim 17, wherein generating the positive training data comprises processing a keyword speech sample to extract the high-frequency component and to extract the low-frequency component, wherein the high-frequency component and the low-frequency component are combined to generate the positive training data.

20. The method of claim 19, wherein the low-frequency component is processed by an equalizing circuit to change the amplitude of one or more frequency bands in the low-frequency component prior to combining the low-frequency component with the high-frequency component.
